(19) United States
(12) Patent Application Publication
(10) Pub. No.: US 2006/0174480 A1
(43) Pub. Date: Aug. 10, 2006

(54) Inspection method and apparatus for mounted electronic components

(75) Inventor: Tosuke Kawada, Chiryu-shi (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: Fuji Machine Mfg. Co., Ltd., Chiryu-shi (JP)

(21) Appl. No.: 11/337,677

(22) Filed: Jan. 24, 2006

(30) Foreign Application Priority Data
Feb. 8, 2005 (JP) 2005-031444

(51) Int. Cl. B23P 21/00

(52) U.S. Cl. 29/833; 29/832; 29/834; 29/720; 29/740

(57) ABSTRACT

An inspection apparatus for mounted electronic components in a component mounting apparatus is provided with camera means capable of placing within its sight a whole printed board. The camera means picks up a first image for the whole printed board which does not have any electronic component mounted thereon. Those but some left of the electronic components to be mounted are then mounted on the printed board. The camera means then picks up a second image for the whole printed board on which those but some left of the electronic components have been mounted. Then, a component mounting correctness judging image processing is executed for judging whether the kind and the mounting position of any electronic component which has been mounted before the second image pickup operation is correct or not, by comparing the second image with the first image, and the some left electronic components are mounted on the printed board in parallel time relation with the component mounting correctness judging image processing for those electronic components mounted before the second image pickup operation.

### INCORPORATION BY REFERENCE

This application is based on and claims priority under 35 U.S.C. 119 with respect to Japanese Application No. 2005-031444 filed on Feb. 8, 2005, the entire contents of which are incorporated herein by reference.

### BACKGROUND OF THE INVENTION

1. Field of the Invention

The present invention relates to a method and apparatus for inspecting the correctness in kinds and mounting positions of electronic components mounted on a printed board.

2. Discussion of the Related Art

Heretofore, a technology described in Japanese unexamined, published patent application No. 6-265324 (hereafter as “Patent Document 1”) has been known as a method of inspecting the mounting correctness of electronic components mounted on a printed board. In this technology, a printed board P2 on which electronic components W have been mounted by a mounting spindle 3 at a mounting position on a table 2 is transferred along the table 2 to an inspection position on the downstream side to be positioned and another printed board P1 having no electronic component mounted thereon is newly transferred and positioned to the mounting position on the table 2, in which state the mountings on the printed board P1 at the mounting position are performed in parallel time relation with the inspection for the mounting correctness of the printed board P2 at the inspection position. Thus, the time taken to inspect for the mounting correctness after the mounting operations is shared with the time taken to perform the mountings on another printed board, and it is unnecessary to take a substantial additional time for the inspection for the correctness of the mounting state, so that the manufacturing efficiency can be enhanced.

Further, another technology described in Japanese unexamined, published patent application No. 7-174519 (hereafter as “Patent Document 2”) has been known as an apparatus for inspecting the mounting correctness of electronic components mounted on a printed board. In this apparatus, a plurality of image pickup cameras 3, 4 are juxtaposed in an image pickup direction and are movable by drive means relative to a printed board 2. These cameras 3, 4 pickup the images of plural divided sections on a surface of the printed board 2, whereby the mounting state of the electronic components can be recognized from the result of such image pickup operation. Further, taking the positional relation between the cameras 3 and 4 and the control procedure into consideration, the cameras 3, 4 are operated to be moved in parallel time relation with, e.g., an image processing needing a long period of time, so that the inspection time period can be shortened as a whole.

However, in the inspection method described in Patent Document 1, a mounting inspection camera device 16 for picking up the mounting state of the electronic components is designed to perform the image pickup of a narrow area which corresponds to the working area of each of the mounting spindles 3. Thus, it is impossible to pick up at a time the images of plural components mounted on the printed board, and where a mounted electronic component is large in dimension, it is also impossible to pick up the images of all the parts of the large-dimension component. In order to detect any defect in mounting of all the components or the large-dimension component mounted on the printed board, such detection must be done by the combination of a plurality of pickup images, whereby a lot of time and effort is required for the image processing.

In addition, in the inspection method described in Patent Document 2, since the inspection apparatus for the mounting state of the electronic components mounted on the printed board is provided independently of an apparatus for mounting the electronic components on the printed board, a problem arises in that an adequate countermeasure cannot be taken immediately upon the detection of any defect in the mounting state.

### SUMMARY OF THE INVENTION

It is therefore a primary object of the present invention to provide an improved inspection method and apparatus for mounted electronic components, capable of detecting a defect in mounting of any mounted electronic component and also capable of taking an adequate countermeasure immediately upon detection of such a defect.

According to one aspect of the present invention, there is provided a method of inspecting mounted electronic components in a component mounting apparatus for mounting electronic components on a printed board. The inspection method comprises the steps of providing camera means capable of placing within its sight the whole printed board positioned at a predetermined position; making the camera means perform an image pickup operation for the whole printed board positioned at the predetermined position which does not have any electronic component mounted thereon or which has some electronic components mounted thereon; subsequently mounting electronic components on the printed board positioned at the predetermined position; making the camera means perform another image pickup operation for the whole printed board having the electronic components subsequently mounted thereon; and performing a component mounting correctness judging image processing for judging whether the kind or the mounting position of any electronic component mounted after the former image pickup operation is correct or not, by comparing the image picked up by the latter image pickup operation with the image picked up by the former image pickup operation.

With this construction in the first aspect, the camera means picks up the image of the whole printed board positioned at the predetermined position which does not have any electronic component mounted thereon or which has some electronic components mounted thereon, electronic components are then mounted on the printed board positioned at the predetermined position, and the camera means then picks up another image for the whole printed board positioned at the predetermined position on which the electronic components are mounted after the former image pickup operation. Thereafter, the latter image is compared with the former image, so that any error or defect in the kinds and the mounting positions of the electronic components which were mounted after the former image pickup operation can be detected easily and speedily.

According to another aspect of the present invention, there is provided an inspection apparatus for mounted electronic components in a component mounting apparatus having a board transfer device for loading a printed board to a loading position to position and clamp the printed board to a predetermined position; a component supply device for supplying electronic components; and a component placing device for picking electronic components supplied by the component supply device and for mounting the electronic components on the printed board. The inspection apparatus comprises camera means capable of placing within its sight the whole printed board positioned at the predetermined position.

With this construction in another aspect, the images of all of the electronic components mounted on the printed board can be picked up at a time, and thus, even if an electronic component mounted is large in dimension, the image of the whole electronic component large in dimension can be picked up. Therefore, the detection for any defect in mounting all of the electronic components or the large-dimension electronic component mounted on the printed board can be carried out by combining the smallest number of pickup images, so that the image processing therefor can be executed easily and speedily.

### BRIEF DESCRIPTION OF THE DRAWINGS

The foregoing and other objects and many of the attendant advantages of the present invention may readily be appreciated as the same becomes better understood by reference to the preferred embodiments of the present invention when considered in connection with the accompanying drawings, wherein like reference numerals designate the same or corresponding parts throughout several views, and in which:

FIG. 1 is a perspective view showing the schematic construction of a component mounting apparatus incorporating an inspection apparatus therein in a first embodiment according to the present invention;

FIGS. 2A and 2B jointly show a flowchart for executing an inspection method for mounted electronic components in the first embodiment;

FIG. 3 is a partial flowchart constituting a part of the flowchart shown in FIGS. 2A and 2B;

FIG. 4 is a representation showing an initial or first pickup image of a printed board in the first embodiment;

FIG. 5 is a representation showing another or second pickup image of the printed board in the first embodiment;

FIG. 6 is a representation showing a modified pickup image processed from the second pickup image shown in FIG. 5 in the first embodiment;

FIG. 7 is a representation showing a further or third pickup image of the printed board in the first embodiment;

FIG. 8 is a representation showing a modified pickup image processed from the third pickup image shown in FIG. 7 in the first embodiment;

FIG. 9 is a partial flowchart for executing an inspection method for mounted electronic components in a second embodiment;

FIG. 10 is a representation showing a pickup image of a printed board in the second embodiment;

FIG. 11 is a representation showing another pickup image of the printed board in the second embodiment;

FIG. 12 is a representation showing a modified pickup image processed from that shown in FIG. 11 in the second embodiment;

FIG. 13 is a partial flowchart for executing an inspection method for mounted electronic components in a third embodiment;

FIG. 14 is a representation showing an initial or first pickup image of a printed board in the third embodiment;

FIG. 15 is a representation showing another or second pickup image of the printed board in the third embodiment;

FIG. 16 is a representation showing a modified pickup image processed from that shown in FIG. 15 in the third embodiment; and

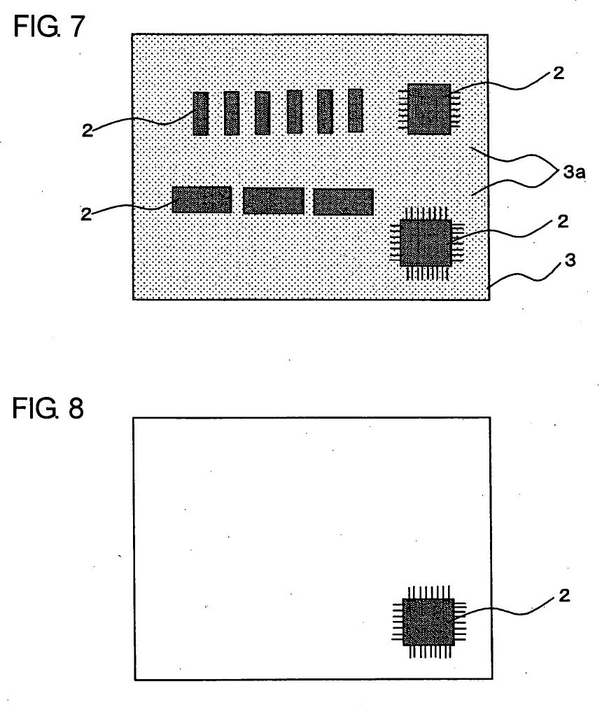

FIG. 7 is a representation showing another or third pickup image of the printed board in the third embodiment.

### DESCRIPTION OF PREFERRED EMBODIMENTS OF THE INVENTION

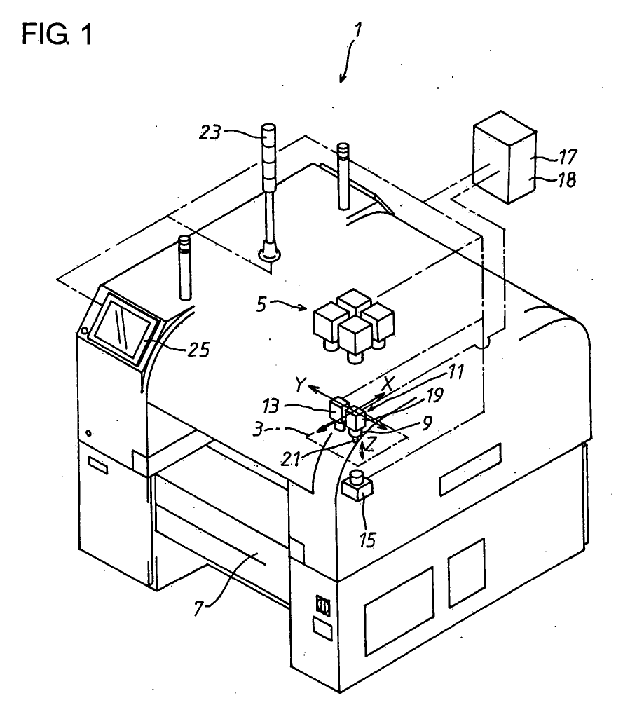

Hereinafter, an inspection method and apparatus for mounted electronic components in a first embodiment will be described with reference to the accompanying drawings. FIG. 1 is a perspective view showing the schematic construction of a component mounting apparatus 1 incorporating an inspection apparatus for the mounted electronic components 2.

The component mounting apparatus 1 incorporating the inspection apparatus therein is composed of cameral means 5 including cameras, capable of placing at a time in its visual field or sight a whole printed board 3 which is positioned at a predetermined position after being transferred, a board transfer device (not shown) for loading the printed board 3 from a loading position to position the board 3 to the predetermined position, a component placing device 11 having a component mounting head 9 provided on a movable head (not shown) which is supported on a base 7 to be movable in X and Y-directions, a board recognition camera (mark camera) 13 provided on the movable head, a component recognition camera 15 secured to the base 7, a control device 17 for controlling the image pickup operation of the camera means 5 and the mounting operation of the component placing device 11, and a component mounting correctness judging image processing means 18 which is constituted by a programmed function of the control device 17 for processing the image picked up by the camera means 5 to judge the correctness in mounting.

Four cameras constituting the cameral means 5 are disposed at the center of the ceiling portion of the component mounting apparatus 1 in a two-by-two juxtaposition, and the image of the printed board 3 clamped at the predetermined position is picked up from above by the camera means 5. The surface of the printed board 3 of a rectangular shape for which the image is to be picked up is partitioned into four sections by the lines passing across the median points of respective sides, and the four cameras have the sights which respectively cover these partitioned sections. Thus, the images for the whole printed board 3 can be picked up by the four cameras at a time. The control device 17 is operable to control the timing at which the camera means 5 picks up the images, and the images picked up by the camera means 5 are subjected to an image processing by the component mounting correctness judging image processing means 18, so that an error (or defect) in mounting can be detected.

Although not shown in the drawings, the board transfer device is composed of conveyer belts respectively guided along guide rails which are juxtaposed to extend in the Y-direction for loading the printed board 3 to a positioning position, a support frame for supporting the loaded printed board 3, an elevator device for elevating the supported printed board 3 to a mounting position (i.e., the predetermined position) and a clamping device for clamping the printed board 3 at the mounting position (the predetermined position).

Over the board transfer device, there is provided an X-direction movable beam (not shown), along which a Y-direction movable head (not shown) is provided to be movable in the Y-direction. The component placing device 11 with the component mounting head 9 and the board recognition camera (mark camera) 13 are carried on the Y-direction movable head to be movable in the Y-direction. The optical axis of the board recognition camera (mark camera) 13 extends in parallel to a Z-axis which is orthogonal to the X-direction as well as to the Y-direction. The X-direction movable beam and the Y-direction movable head are controllable by servomotors through ball screws (both not shown) to be moved in the X and Y-directions respectively, and the operations of the servomotors are controllable by the control device 17.

The component placing device 11 is composed of a support base 19 attached to the Y-direction movable head, the component mounting head 9 guided by the support base 19 to be movable up and down in the Z-direction which is orthogonal to the X-direction as well as to the Y-direction and controllable by another servomotor to be moved up and down, and a suction nozzle 21 protruding downward from the mounting head 9. The suction nozzle 21 takes a cylindrical shape and is formed to pick up and hold an electronic component 2 at its lower end. Further, the timing at which the component placing device 11 performs a component mounting operation is controllable by the control device 17.

Although not shown, a component supply device composed of a plurality of feeders is provided on one side of the component mounting apparatus 1 incorporating the inspection device. The component recognition camera 15 with the optical axis extending in parallel to the Z-direction is provided on the base 7 between the board transfer device and the component supply device. A signaling tower 23 notifying the operator of the occurrence of a defect in mounting protrudes from the top of the component mounting apparatus 1, and an operator's panel 25 is provided tilted inside at a front top portion on one side of the component mounting apparatus 1.

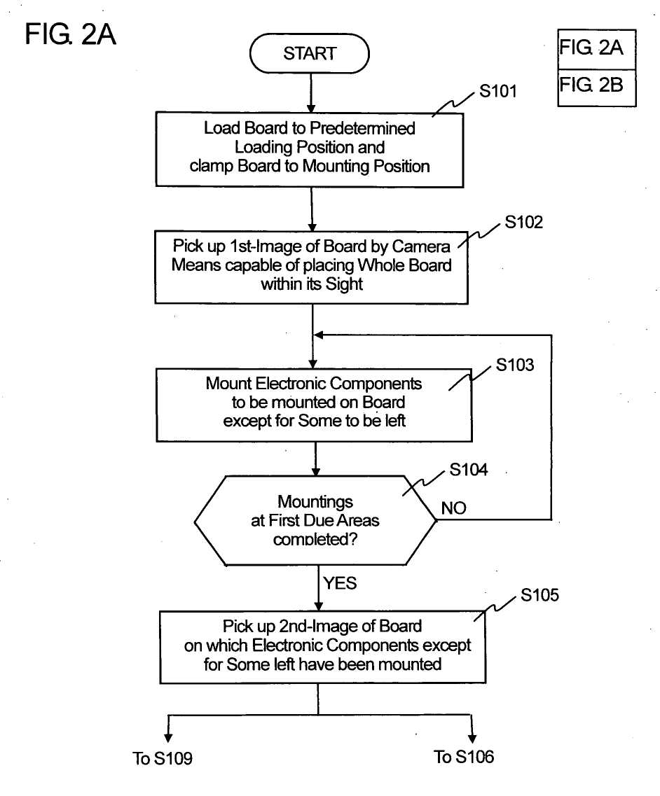

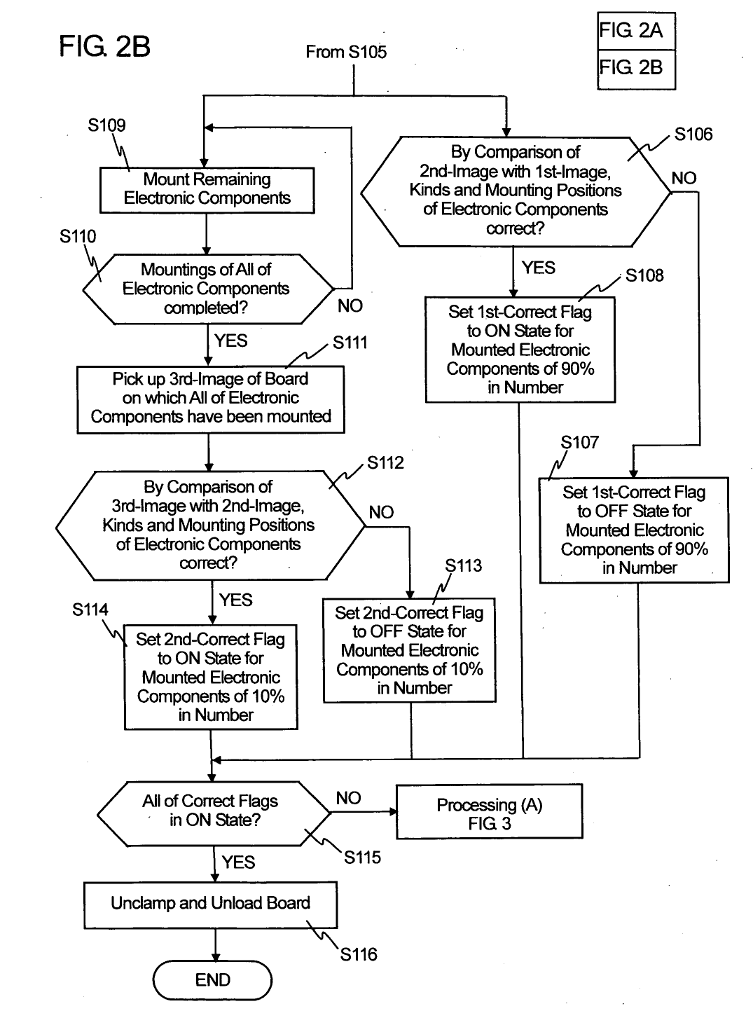

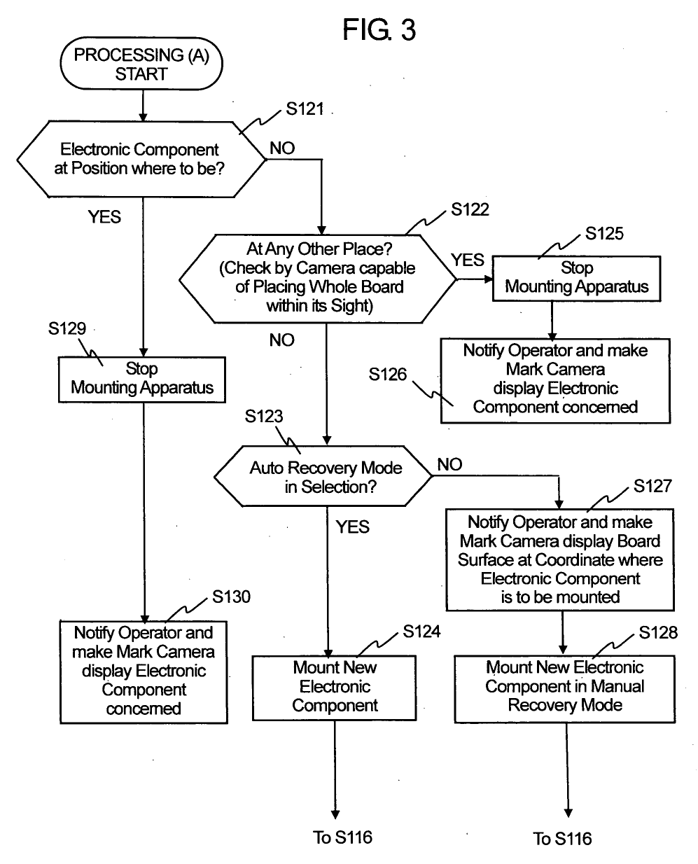

Next, in accordance with flowcharts shown in FIGS. 2A, 2B and 3 which are executed by the control device 17, description will be made regarding a method of mounting the electronic components 2 by the used of the component mounting apparatus 1 which is constructed as aforementioned with the inspection device incorporated therein for the mounted electronic components 2 and of inspecting the correctness in mounting of the electronic components 2.

First of all, a printed board 3 is loaded by the board transfer device (not shown) to a positioning position and is supported on the support frame (not shown). The supported printed board 3 is then moved by the elevator device (not shown) upward to the position where the mountings of the electronic components 2 are performed, and is fixedly clamped by the clamping device (step S101).

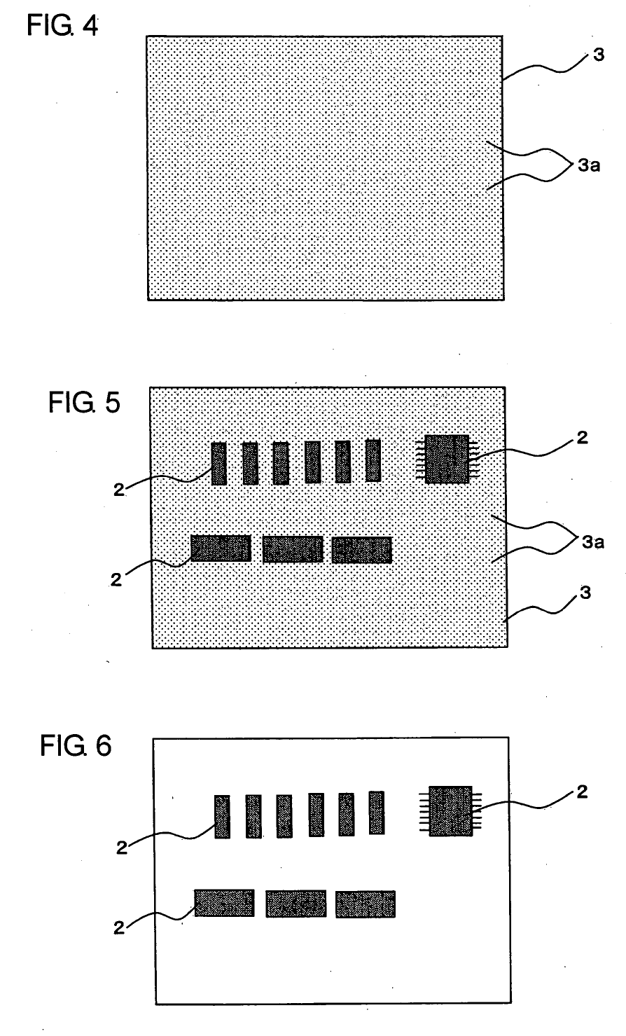

Then, the image of the printed board 3 being clamped is picked up as an initial or first image by the camera means 5. At this time, the whole printed board 3 before component mounting operations is placed within the sight of the four cameras, which therefore pick up the images of the four partitioned sections simultaneously (step S102). As a consequence, as shown in FIG. 4, images are picked up of the whole printed board 3, numerous pinholes 3a opening to the surface of the printed board 3 and a circuit diagram (not shown).

Thereafter, of the electronic components 2 to be mounted on the printed board 3, those of 10% in number are left not to be mounted and the remaining components 2 of 90% in number are mounted on the printed board 3 (step S103). In mounting each component, the board recognition camera 13 detects a board mark (not shown) provided on the fixedly positioned printed board 3, and the control device 17 calculates a coordinate position at which each component is to be mounted, by performing a position compensation operation based on the detected position of the board mark. Further, for each electronic component 12 held on the lower end surface of the suction nozzle 21, the component recognition camera 15 detects a misalignment of the electronic component 2 relative to the center axis of the suction nozzle 21, and the control device 17 compensates the moving amounts of the suction nozzle 21 in either or both of the X and Y-directions for the detected misalignment whenever such compensation is necessary, whereby the electronic component 2 can be mounted at the calculated coordinate position correctly.

Whether or not the mountings of the electronic components 2 of 90% in number have been completed is detected by calculating the total mounting time taken for the mounted electronic components 2. When the mounting operations are completed for the electronic components 2 exceeding 90% in number, any subsequent mounting operations is not performed, in which case the component mounting head 9 is moved out of the sight of the camera means 5 (step S104). The movement for brining the component mounting head 9 out of the sight of the camera means 5 can be replaced by the operation of the component mounting head 9 going to the component supply device for another electronic component 2 to be mounted newly and, when so performed, becomes unnecessary to be instructed independently.

Then, the camera means 5 takes, as another or second image, the image of the whole printed board 3 with the electronic components 2 having been mounted by 90% in number (step S105). At this step, as shown in FIG. 5, there are taken images of the mounted electronic components 2, the printed board 3, the numerous pinholes 3 on the surface of the printed board 3 and the circuit diagram (not shown).

Thereafter, a component mounting correctness judging image processing is performed to compare the image (i.e., second image) shown in FIG. 5 taken at step S105 with the image (i.e., first image) shown in FIG. 4 take at step S102, and the correctness in the mounting state is judged by detecting one or more defects in the kinds of the mounted electronic components 2 as well as in the mounting positions of the same (step S106). At this step, as shown in FIG. 6, an image processing is carried out to delete the images of the printed board 3, the numerous pinholes 3a on the surface of the printed board 3 and the circuit diagram (not shown), and only the image data of the electronic components 2 which are necessary to detect such defects in mounting are left to be displayed as a modified image processed from the second image shown in FIG. 5, so that the detection of the defects can be carried out speedily and easily.

When any defect in the mounting state is detected at step S106, a first correct flag (not shown) is set to OFF state for the mounted electronic components 2 of 90% in number (step S107), and the routine proceeds to step S115.

When the mounting state is detected to be correct at step S106, on the contrary, the first correct flag is set to ON state for the mounted electronic components of 90% in number (step S108), and the routine proceeds to step S115.

The electronic components 2 of the remaining 10% in number are mounted on the printed board 3 in parallel time relation with the image processing executed at step S106 (step S109). In this way, the image processing for the images of the electronic components 2 of the 90% in number having been mounted on the printed board 3 is executed in parallel time relation with the mounting operations of the electronic components 2 of the remaining 10% in number, and therefore, the mounting and inspection operations can be completed in a shorter period of time than that taken where the inspection image processing for all the electronic components 2 is executed in serial time relation after the completion of the mounting operations of all the electronic components 2.

Whether the remaining electronic components 2 have all been mounted or not is judged in dependence on whether a predetermined mounting program for all the electronic components 2 has been completed or not (step S110).

When a judgment made at step S110 is that all the electronic components 2 have been mounted, the mounting operations therefor are terminated, and the camera means 5 picks up, as a further or third image, the image of the whole printed board 3 with all the electronic components 2 having been mounted thereon (step S111). At this step, as shown in FIG. 7, images are picked up of all the mounted electronic components 2, the printed board 3, the numerous pinholes 3a on the surface of the printed board 3 and the circuit diagram (not shown).

Subsequently, another component mounting correctness judging image processing is executed by the control device 17 to compare the image (i.e., third image) shown in FIG. 7 picked up at step S111 with the second image shown in FIG. 5 picked up at step S105, and thus, detection is executed for any defect in the kind and the mounting position of any electronic component 2 mounted additionally, so that the correctness in the mounting state is judged (step S112). At this step, as shown in FIG. 8, the image processing is carried out to delete the images of the electronic components 2 mounted at step S103, the printed board 3, the numerous pinholes 3a on the surface of the printed board 3 and the circuit diagram (not shown), and only the image data of each remaining electronic component 2 mounted at step S109 is left to remain on the display as a modified image processed from the third image shown in FIG. 7, so that the detection of any defect in mounting of any electronic component 2 mounted at step S109 can be carried out speedily and easily. Although this image processing can be executed after the completion of the mountings of all the electronic components 2, the electronic components 2 to be mounted as those remaining of 10% in number are decreased in number, and thus, the image processing for those of the decreased number can be executed in a short period of time, so that the mounting and inspection operations of all the electronic components 2 can be completed efficiently as a whole.

When any defect in the mounting state is detected at step S112, another or second correct flag for the electronic components 2 of 10% in number is set to OFF state (step S113), and the routine proceeds to step S115.

When it is judged at step S112 that the remaining electronic components 2 of 10% in number have been mounted correctly on the printed board 3, the second correct flag is set to ON state (step S114), and the routine is advanced to step S115.

Thereafter, a judgment is made of whether or not all the correct flags have been in ON state (step S115).

When it is judged that all the correct flags are in ON state, the printed board 3 is unclamped and is unloaded from the mounting station (step S116).

When either of the correct flags is judged to be in OFF state at step S115, the routine is moved to step S121 for a processing (A) shown in FIG. 3. Upon the detection of any defect in mounting, for the type of the mounting defect, a judgment is made of whether or not each of the electronic components 2 under inspection is at a position where it is to locate on the printed board 3 (step S121).

If any electronic component 2 under inspection is not at the due position to locate, the camera means 5 is controlled to put the whole printed board 3 within the sight thereof and then to check whether or not the electronic component 2 under inspection is at any other place on the printed board 3 as a result of falling down on the way of conveyance over the due location, that is, over a programmed target position therefor (step S122).

If the electronic component 2 under inspection is not at any other place on the printed board 3, it is judged whether an auto recovery mode has been selected or not (step S123).

In the case of the auto recovery mode having been selected, a new electronic component 2 to replace that not found is supplied from the component supply device and is mounted at the due location on the printed board 3 (step S124). Thereafter, the routine is moved to step S116 shown in FIG. 2(B).

Further, if the electronic component 2 under inspection is found to be at any other place on the printed board 3 at step S122, the operation of the component mounting apparatus 1 is discontinued (step S125).

In this case, the control device 17 notifies the operator by making the signal tower 23 turn on or by issuing any other signal, positions the board recognition camera (mark camera) 13 over the coordinate position where the fallen electronic component 2 lies, and displays the coordinate position and the image of the fallen electronic component 2 (step S126). Thus, it becomes possible for the operator to recognize the fallen electronic component 2 and then, to pick up the same by manipulating the operator's panel 25.

When it is judged at step S123 that the auto recovery mode has not been selected, the notification to the operator is executed likewise, and the control device 17 positions the board recognition camera (mark camera) 13 over the coordinate position where the due electronic component 2 has not been mounted, to display a surface area at the coordinate position of the printed board 3 and prompts the operator to check the absence of the due electronic component 2 at that board surface area (step S127).

Upon the recognition of such absence, the operator selects a manual recovery mode and operates the component mounting apparatus 1 to mount a new replacing electronic component 2 at the programmed target coordination position for the same (step S128). Upon completion of the manual recovery mode operation, the routine is moved to step S116 shown in FIG. 2(B).

Further, when it is judged at step S121 that the electronic component under inspection is present at the position due to mount, the control device 17 stops the operation of the component mounting apparatus 1 (step S129).

Then, the control device 17 notifies the operator of the presence of the electronic component 2 under inspection, then positions the board recognition camera (mark camera) 13 over the coordinate position occupied by the electronic component 2 under inspection to display the same, and prompts the operator to confirm that the mounted electronic component 2 is not correct or that the deviation in mounting position of the mounted electronic component 2 from the due position is beyond a predetermined allowance (step S130).

All the electronic components 2 specified by either one of the correct flags being in OFF state are inspected one at a time through the aforementioned inspection processing (A) shown in FIG. 3. In a modified form, several electronic components 2 so specified may be inspected at a time in parallel time relation. At step S130, the operator may confirm that the electronic component 2 under inspection is neither wrong in the kind nor wrong in the mounting position. In that case, although not illustrated in the aforementioned inspection processing (A) shown in FIG. 3, the operator then instructs the control device 17 to execute the aforementioned inspection processing (A) for the next one of the electronic components 2 specified by either one of the correct flags being in OFF state.

Although in the foregoing first embodiment, all the electronic components 2 are allocated between those of 90% in number to be mounted at a first stage and those of 10% in number to be mounted at a second stage following the fist stage, such allocation is made by way of an example, and the present invention is not limited to such allocation. The number of the electronic components 2 to be left for the mountings at the second stage is set so that the time taken for the component mounting correctness judging image processing which judges the correctness in mounting of the electronic components 2 mounted at the first stage well balances with the time taken for the mountings of the remaining electronic components 2 performed in parallel time relation. As a consequence, the allocation can be arbitrarily set to complete the mounting and inspection operations of all the electronic components in the shortest period of time as a whole.

For example, where the electronic components 2 to be mounted on the printed board 3 are small in number, those of 100% in number are mounted by the repetitive executions of step S103, in which case steps S109 through S114 may not be executed or may be executed without any effect. In this modified case, the judgment at step S115 is executed to check the ON/OFF state of the first correct flag only. In an alternative modified case, those of 100% in number are mounted by the repetitive executions of step S109, in which case steps S103 through S108 may not be executed or may be executed without any effect. In this alternative modified case, the judgment at step S115 is executed to check the ON/OFF state of the second correct flag only. That is, the allocation between those to be mounted at the first stage and those to be mounted at the second stage following the fist stage may also be alterable flexibly between a 100 to 0 ratio and a 0 to 100 ratio.

### SECOND EMBODIMENT

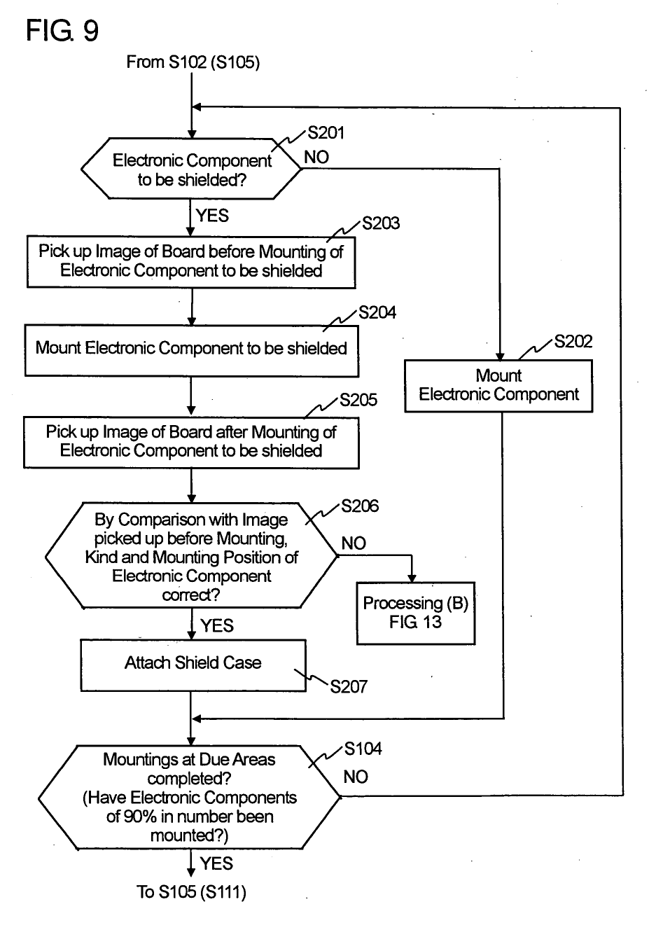

Hereinafter, an inspection method for the correctness in mounting of mounted electronic components in a second embodiment will be described with reference to a partial flowchart shown in FIG. 9. It may be the case that a shield case for blocking electromagnetic waves or the like is mounted to cover a particular electronic component in the mounting operation. In this case, it becomes difficult to judge the correctness in the mounting state of such a shielded electronic component after the attaching of the shield case, and hence, it is necessary to carry out the inspection at a different stage before the attaching of the shield case.

It is to be noted here that since the construction of an inspection device used for practicing the inspection method in the second embodiment is the same as that described in the foregoing first embodiment, the description of the construction will be omitted for the sake of brevity.

First of all, it is judged whether the electronic component 2 to be mounted is an electronic component 2a to be shielded by a shield case (step S201).

When the electronic component 2 is judged not to be shielded, the routine is moved to step S202, wherein the electronic component 2 is mounted on the printed board 3. Then, the routine proceeds to step S104 (or proceeds to step S110 where the ongoing mounting processing is being executed for the electronic components 2 of the remaining 10% in number).

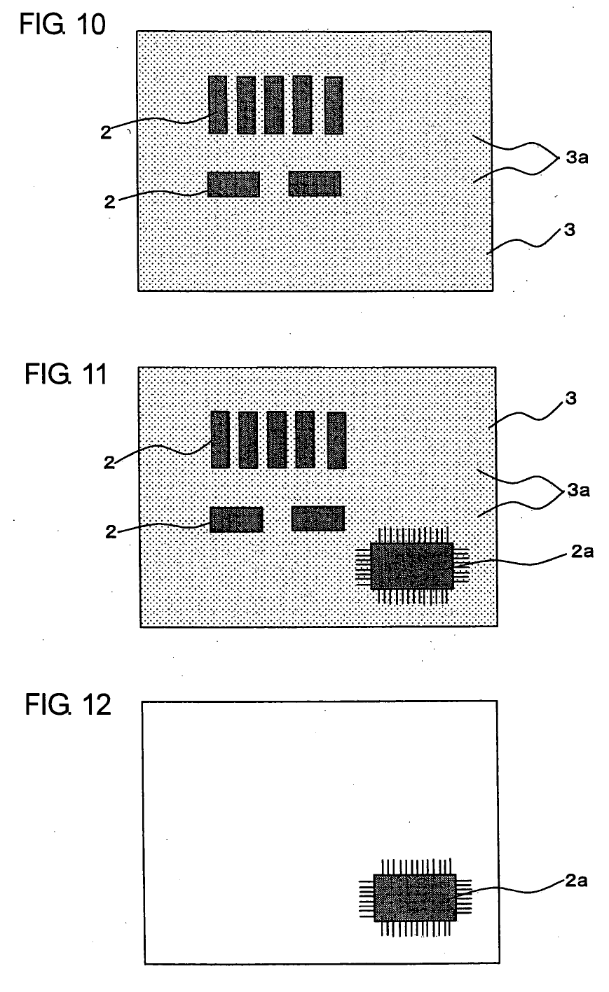

When the judgment at step S201 is that the electronic component under process is one 2a to be shielded, the camera means 5 picks up the image of the whole printed board 3 prior to the mounting of the electronic component 2a to be shielded (step S203). At this step, as shown in FIG. 10, the images are picked up of the printed board 3, the numerous pinholes 3a on the surface of the printed board 3, the circuit diagram (not shown) and any electronic component (not to be shielded) if the same has already been mounted at step 202.

Subsequently, the electronic component 2a to be shielded is mounted on the printed board 3 (step S204).

Then, the camera means 5 picks up the image of the whole printed board 3 on which the electronic component 2a to be shielded has been mounted (step S205). At this step, as shown in FIG. 11, the images are picked up of the electronic component 2a to be shielded, the printed board 3, the numerous pinholes 3a on the surface of the printed board 3, the circuit diagram (not shown) and any electronic component 2 (not to be shielded) which was mounted at step 202.

Thereafter, a component mounting correctness judging image processing is executed by the control device 17 to compare the image shown in FIG. 11 picked up at step S205 with the image shown in FIG. 10 which was picked up at step S203 prior to the mounting of the electronic component 2a to be shielded, and thus, detection is executed for a defect in the kind and the mounting position of the mounted electronic component 2a to be shielded, so that the correctness in the mounting state is judged of the mounted electronic component 2a (step S206). At this step, as shown in FIG. 12, an image processing is carried out to delete the images of the electronic components 2 not to be shielded, the printed board 3, the numerous pinholes 3a on the surface of the printed board 3 and the circuit diagram (not shown), and only the image data of the electronic component 2a to be shielded which is necessary for the detection of any defect in mounting is left to remain on the display, so that the detection of the defect in mounting can be carried out speedily and easily. In this way, where the shield case is to be mounted with itself piled on the mounted electronic component 2a to be shielded, the same is inspected just before the attaching of the shield case thereto, so that it can be realized reliably to defect any defect in mounting which becomes impossible to defect after the attaching of the shield case.

When the defect in mounting of the electronic component 2a is detected at step S206, another processing (B) is executed in the same manner as the processing (A) in the foregoing first embodiment.

When the mounting of the electronic component 2a to be shielded is judged to be correct at step S206, the shield case is then attached (step S207).

After the attaching of the shield case, the routine is linked to step S104 of the flowchart shown in FIG. 2(A) though in this case, the electronic component 2a to be mounted is different from that in the foregoing first embodiment, and a judgment is made of whether those of the 90% in number of the electronic components 2 to be mounted have been mounted or not (step S104).

Where the inspection in the present embodiment is being executed during the mounting processing for the electronic components of the remaining 10% in number, the routine is liked to step S110 after the mounting of the shield case, and it is judged whether the mounting processing for all the electronic components 2 have been completed or not (step S110).

Although the present embodiment is described as an example in the case that the correctness in mounting the electronic component 2a to be shielded by the shield case is inspected prior to the attaching of the shield case, the present invention is not limited to the application in the exemplified case using the shield case. For example, in the case that a chip and another chip are used with one piled on the other like a COC (Chip On Chip) package, the inspection may be carried out for the correctness in mounting of an already mounted chip prior to the subsequent mounting of another piled chip thereto.

### THIRD EMBODIMENT

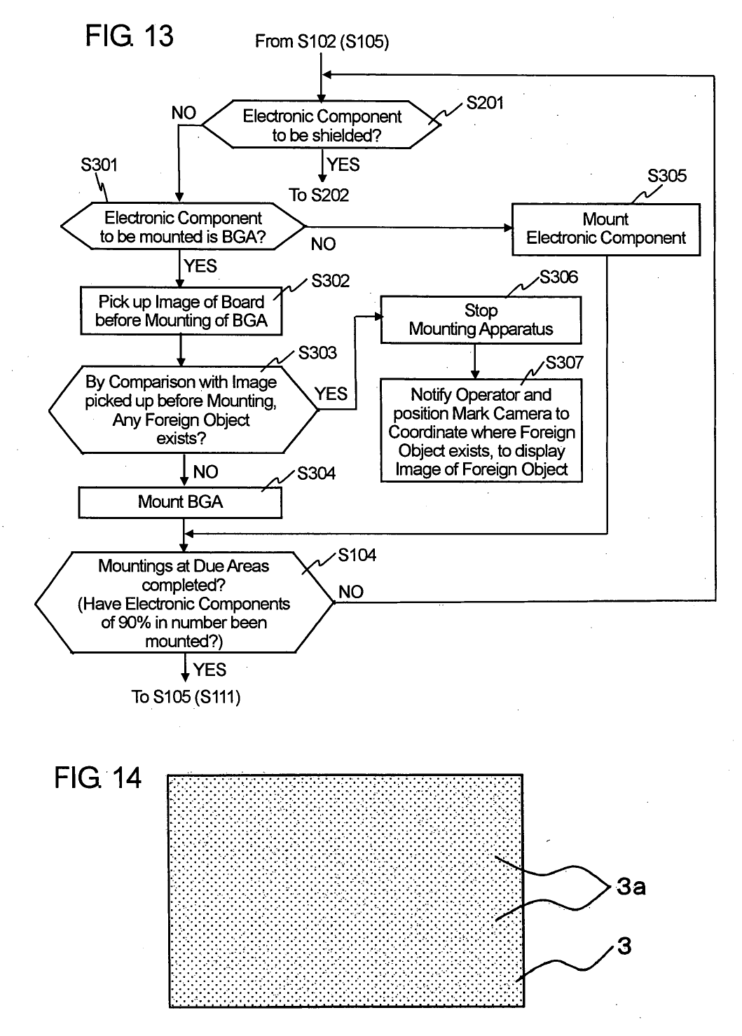

Hereinafter, an inspection method in a third embodiment for detecting the existence of any foreign object will be described with reference to a partial flowchart shown in FIG. 13. Where mounted is a packaged electronic component like BGA (Ball Grid Array) which is large in its area to occupy the surface of the printed board 3, it is likely that any foreign object on the printed board will be unable to detect as a result of being hidden under the packaged electronic component. Therefore, it becomes necessary to inspect the packaged electronic component at another stage or station before the mounting. It is to be noted here that since the construction of an inspection device used for practicing the inspection method in the third embodiment is the same as that described in the foregoing first embodiment, the description of the construction will be omitted for the sake of brevity.

At step S102, as shown in FIG. 14, the images are picked up of the printed board 3, the numerous pinholes 3a at the surface of the printed board 3 and the circuit diagram (not shown) as in the foregoing first embodiment.

First of all, a judgment is made of whether the electronic component to be mounted is a BGA 29 or not (step S301).

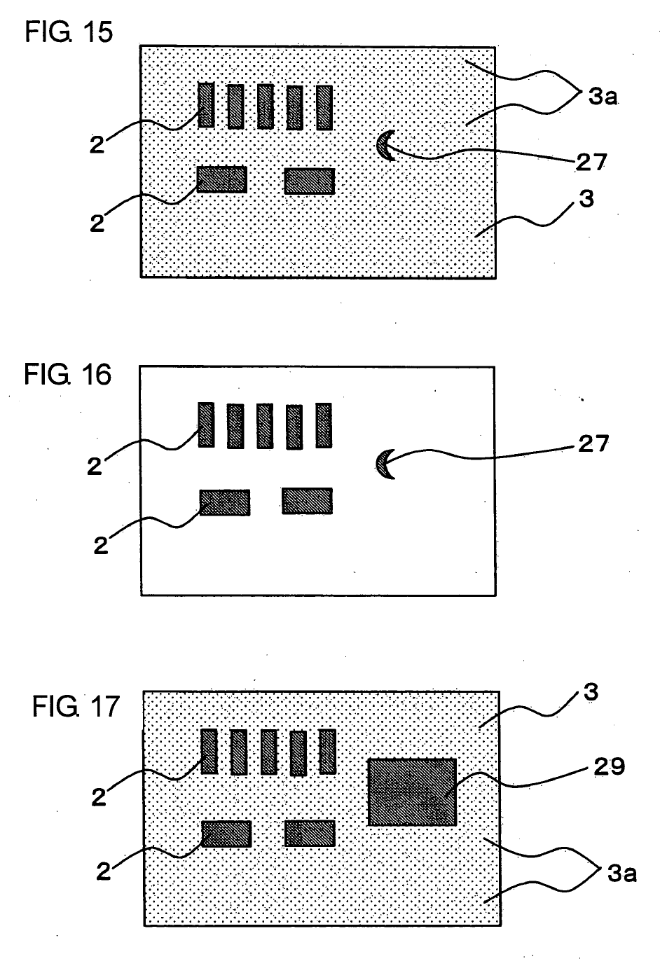

When the electronic component to be mounted is judged to be a BGA 29 at step 301, the cameral means 5 picks up the image of the whole printed board 3 prior to the mounting of the BGA 29 (step S302). At this step, as shown in FIG. 15, the images are picked up of the printed board 3, the numerous pinholes 3a on the surface of the printed board 3, already mounted electronic components 2, a foreign object 27 if the same exists, and the circuit diagram (not shown).

When the electronic component to be mounted is judged not to be the BGA 29 at step 301, the routine proceeds to step S305 to mount the electronic component 2 and then proceeds to step S104.

Thereafter, an image processing is executed by the control device 17 to compare the image shown in FIG. 15 picked up at step S302 with the image (the first picked-up image) shown in FIG. 14 which was picked up at step S102 prior to the mounting, and thus, as a foreign object detection image processing, detection is executed for the existence of the foreign object 27 (step S303). At this step, an image processing is carried out for a modified image shown in FIG. 16 which is made by processing the image shown in FIG. 15 to delete the images of the printed board 3, the numerous pinholes 3a on the surface of the printed board 3 and the circuit diagram (not shown), so that the detection of the foreign object 27 can be carried out speedily and easily. In this way, since the existence of the foreign object 27 within a due area for the mounting of the large-area, packaged electronic component like the BGA 29 is checked before the mounting of the same, it can be prevented that an error in inspection takes place by the cause of the foreign object 27 being hidden under the BGA 29 as shown in FIG. 17 after the mounting of the BGA 29.

If the foreign object 27 is detected at step S303, the operation of the component mounting apparatus 1 is stopped (step S306).

In this case, the control device 17 notifies the operator by making the signal tower 23 turn on or by issuing any other signal, positions the board recognition camera (mark camera) 13 over a coordinate position where the foreign object 27 is detected, and displays the image of the foreign object 27. Thus, it becomes possible for the operator to recognize the foreign object 27.

When no foreign object is detected at step S303, the control device 17 controls the component mounting apparatus 1 to mount the BGA 29 on the printed board 3 (step S304).

After the mounting of the BGA 29, the routine proceeds to step S104, wherein a judgment is made of whether those of 90% in number of the electronic components 2 to be mounted have been mounted or not (step S104).

Where the inspection in the present embodiment is being executed for the mounting processing of the electronic components 2 of the remaining 10% in number, the routine proceeds to step S110 after the mounting of the BGA 29, and it is judged whether the mounting processing for all the electronic components 2 have been completed or not (step S110).

Although the present embodiment is described as an example in the case that the foreign object 27 on the printed board 3 is inspected prior to the mounting of the BGA 29, the present invention is not limited to the application in the exemplified case using BGA 29. For example, in the case that a foreign object is liable to be hidden within the area at which a large-area, packaged electronic component is mounted, the present invention may be practiced to carry out the inspection for the foreign object prior to the mounting of such a large-area, packaged electronic component.

Although in the second and third embodiments, the camera means 5 including four cameras is used to pick up the image of the whole printed board 3, the present invention is not limited to the use of the camera means 5. Instead, there may be used a camera such as, e.g. mark camera, which is capable of selectively picking up the images of mounting due areas on the printed board 3 respectively allotted for the mountings of electronic components 2. By doing so, the inspection for electronic components 2 on the printed board 3 can be carried out effectively by the use of an existing facility without accompanying any additional cost.

Finally, various features and the attendant advantages of the foregoing embodiments will be summarized as follows.

In one aspect of the foregoing first embodiment shown in FIGS. 1 to 8, the camera means 5 picks up an image (FIG. 4 or 5) of the whole printed board 3 positioned at the predetermined position which does not have any electronic component mounted thereon or which has some electronic components 2 mounted thereon, electronic components 2 are then mounted on the printed board 3 positioned at the predetermined position, and the camera means 5 then picks up another image (FIG. 7) of the whole printed board 3 positioned at the predetermined position on which the electronic components 2 have been mounted. Thereafter, the latter image (FIG. 7) is compared with the former image (FIG. 5), so that any defect in the kinds and the mounting positions of the electronic components 2 which are mounted after the pickup operation of the former image (FIG. 5) can be detected easily and speedily.

In another aspect of the foregoing first embodiment shown in FIGS. 1 to 8, the former image (FIG. 4) is picked up of the whole printed board 3 which does not have any electronic component mounted thereon, the latter image (FIG. 7) is picked up of the whole printed board 3 which have all of the electronic components 2 to be mounted thereon, and the latter image (FIG. 7) is compared with the former image (FIG. 4). Thus, any defect in the kinds and the mounting positions of all of the mounted electronic components 2 can be detected easily and speedily.

In still another aspect of the foregoing first embodiment shown in FIGS. 1 to 8, the image processing for the image (FIG. 5) of the printed board 3 on which those but some of the electronic components 2 to be mounted have been mounted is executed in parallel time relation with the mountings of the some electronic components 2 left. Thus, the mounting and inspection operations for all of the electronic components 2 to be mounted can be done speedily in a shorter period of time than the time period which may otherwise be taken if the image processing for the inspection were performed in a serial time relation after the mounting operations of all of the electronic components 2. Although the image processing for inspecting the some electronic components 2 left is performed after the mountings of the same, it can be done in a short period of time because the some electronic components left are decreased in number. As a result, the mounting and inspection operations for all of the electronic components 2 can be completed efficiently as a whole. In the image processing, the image (FIG. 5) picked up for the whole printed board 3 on which those but some left of the electronic components 2 to be mounted have been mounted is compared with the image (FIG. 4) which is picked up for the whole printed board 3 before the mountings of those electronic components 2 (or the image (FIG. 7) picked up for the whole printed board 3 on which the some electronic components 2 left have also been mounted is compared with the image (FIG. 5) picked up for the whole printed board 3 on which those of the electronic components 2 are mounted except for the some electronic components left), so that any defect in the kinds and the mounting positions of the mounted electronic components 2 can be detected easily and speedily.

In the foregoing second embodiment shown in FIGS. 9 to 12, any defect in mounting can be detected speedily by making the camera means 5 previously pick up the image (FIG. 10) of the mounting area on which the electronic component 2a is to be mounted and then by performing the image processing to compare the image (FIG. 11) picked up after the mounting of the electronic component 2a with the previously picked-up image (FIG. 10). In particular, even where the already mounted electronic component 2a is liable to be covered by another electronic component piled thereon, it can be realized to detect any defect in mounting of the subsequently covered electronic component 2a reliably.

In the foregoing third embodiment shown in FIGS. 13 to 17, in the mid course of the mounting operations for the electronic components 2, an image processing is executed in such a way that the image (FIG. 15) of a mounting programmed area on the printed board 3 which area has an electronic component 29 to be next mounted thereat is compared with the image (FIG. 14) which was picked up for the mounting program area on the printed board 3 before the mounting operation. Thus, it can be realized to detect any foreign object 27 on the printed board 3 speedily.

In a further aspect of the foregoing first embodiment typically shown in FIG. 1, by the provision of the camera means 5, the images of all of the electronic components 2 mounted on the printed board 3 can be picked up at a time, and thus, even if a mounted electronic component is large in dimension, the image of the whole electronic component large in dimension can be picked up. Therefore, the detection for any defect in mounting of all of the electronic components or a large-dimension electronic component mounted on the printed board 3 can be carried out by combining the smallest number of pickup images, so that the image processing therefor can be executed easily and speedily.

In a still further aspect of the foregoing first embodiment typically shown in FIGS. 2 and 4 to 8, the component mounting correctness judging image processing means (i.e., the control device 17) compares the second image (FIG. 5) of the whole printed board 3 with the first image (FIG. 4) of the whole printed board 3 to detect any defect in the kinds and the mounting positions of those first mounted of the electronic components 2 in parallel time relation with the subsequent mountings of some electronic components 2 left and then, compares the third image (FIG. 7) of the whole printed board 3 with the second image (FIG. 5) of the whole printed board 3 to detect any defect in the kinds and the mounting positions of the some electronic components 2 left and subsequently mounted. Thus, it can be realized to detect any defect in the kinds and the mounting positions of the mounted electronic components 2 easily and speedily. Moreover, it becomes possible to provide the inspection device for the mounted electronic components 2 which device is able to make the component mounting apparatus 1 to perform the mounting operations speedily.

Obviously, numerous further modifications and variations of the present invention are possible in light of the above teachings. It is therefore to be understood that within the scope of the appended claims, the present invention may be practiced otherwise than as specifically described herein.

What is claimed is:

1. A method of inspecting mounted electronic components in a component mounting apparatus for mounting electronic components on a printed board, the method comprising the steps of:
providing camera means capable of placing within its sight the whole printed board positioned at a predetermined position;
making the camera means perform an image pickup operation for the whole printed board positioned at the predetermined position which does not have any electronic component mounted thereon or which has some electronic components mounted thereon;
subsequently mounting the electronic components on the printed board positioned at the predetermined position;
making the camera means perform another image pickup operation for the whole printed board having the electronic components subsequently mounted thereon; and
performing a component mounting correctness judging image processing for judging whether the kind or the mounting position of any electronic component mounted after the former image pickup operation is correct or not, by comparing the image picked up by the latter image pickup operation with the image picked up by the former image pickup operation.

2. The method as set forth in claim 1, wherein:
the former image pickup operation is performed to pick up the image of the whole printed board on which none of the electronic components has been mounted; and
the latter image pickup operation is performed to pick up the image of the whole printed board on which all of the electronic components to be mounted have been mounted.

3. A method of inspecting mounted electronic components in a component mounting apparatus for mounting electronic components on a printed board, the method comprising the steps of:
providing camera means capable of placing within its sight the whole printed board positioned at a predetermined position;
making the camera means perform a first image pickup operation for the whole printed board positioned at the predetermined position which does not have any electronic component mounted thereon;
mounting on the printed board those but some left of the electronic components to be mounted thereon;
making the camera means perform a second image pickup operation for the whole printed board on which those but some left of the electronic components have been mounted;
performing a component mounting correctness judging image processing for judging whether the kind or the mounting position of any electronic component which has been mounted before the second image pickup operation is correct or not, by comparing the image picked up by the second image pickup operation with the image picked up by the first image pickup operation;
mounting the some left electronic components on the printed board in parallel time relation with the component mounting correctness judging image processing;
making the camera means perform a third image pickup operation for the whole printed board on which the some left electronic components have also been mounted; and
performing another component mounting correctness judging image processing for judging whether the kind or the mounting position of any electronic component which was mounted after the second image pickup operation is correct or not, by comparing the image picked up by the third image pickup operation with the image picked up the second image pickup operation.

4. A method of inspecting mounted electronic components in a component mounting apparatus for mounting electronic components on a printed board, the method comprising the steps of:
providing camera means capable of placing within its sight the whole printed board positioned at a predetermined position;
making the camera means perform an image pickup operation for picking up a mounting programmed area on the printed board;
mounting the electronic components on the printed board;
making the camera means perform another image pickup operation for the mounting programmed area on the printed board after the mountings of the electronic components;
performing a component mounting correctness judging image processing for judging whether the kind or the mounting position of any electronic component having been mounted on the printed board is correct or not, by comparing the image picked up after the mountings of the electronic components with the image picked up before the mountings of the electronic components; and
further mounting a new component on at least one of the electronic components having been mounted on the printed board with the new component piled on the at least one of the electronic components.

5. A method of inspecting mounted electronic components in a component mounting apparatus for mounting electronic components on a printed board, the method comprising the steps of:
providing camera means for placing within its sight an area on the printed board in which area the electronic components are to be mounted;
making the camera means perform an initial image pickup operation for a mounting programmed area on the printed board before the mountings of the electronic components;
making the camera means perform another image pickup operation for a subsequent mounting programmed area on the printed board, in a mid course of mountings of the electronic components; and
performing a foreign object detecting image processing for detecting any foreign object on the printed board by comparing the image picked up in the mid course of the mountings of the electronic components with the image picked up by the initial image pickup operation.

6. An inspection apparatus for mounted electronic components in a component mounting apparatus having a board transfer device for loading a printed board to a loading position to position and clamp the printed board to a predetermined position; a component supply device for supplying electronic components; and a component placing device for picking up electronic components supplied by the component supply device and for mounting the electronic components on the printed board; the inspection apparatus comprising:
camera means capable of placing within its sight the whole printed board positioned at the predetermined position.

7. The inspection apparatus as set forth in claim 6, further comprising:
mounting control means for controlling the component placing device to first mount on the printed board those but some left of the electronic components to be mounted on the printed board and subsequently to mount on the printed board the some left electronic components;
image pickup control means for controlling the camera means to pick up a first image of the whole printed board which does not have any electronic component thereon, a second image of the whole printed board on which those but some left of the electronic components to be mounted have been mounted by the component placing device, and a third image of the whole printed board on which the some left electronic components have also been mounted by the component placing device; and
component mounting correctness judging image processing means for judging the correctness in the kinds and the mounting positions of the electronic components mounted on the printed board by:
a) in parallel time relation with the subsequent mountings of the some left electronic components, comparing the second image of the whole printed board with the first image of the whole printed board to detect any error in the kinds and the mounting positions of those first mounted of the electronic components; and
b) then, comparing the third image of the whole printed board with the second image of the whole printed board to detect any error in the kinds and the mounting positions of the some left electronic components subsequently mounted.
